(19) United States
(12) Patent Application Publication
(10) Pub. No.: US 2008/0071559 A1
(43) Pub. Date: Mar. 20, 2008

(54) Augmented reality assisted shopping

(76) Inventor: Juha Arrasvuori, Tampere (FI)

Correspondence Address: Hollingsworth & Funk, LLC, Suite 125, 8009 34th Avenue South, Minneapolis, MN, 55425, US

(21) Appl. No.: 11/523,162

(22) Filed: Sep. 19, 2006

(51) Int. Cl. G06Q 10/00; G06Q 30/00

(52) U.S. Cl. 705/1

(57) ABSTRACT

Facilitating shopping for a tangible object via a network using a mobile device involves obtaining a graphical representation of a scene of a local environment using a sensor of the mobile device. Graphical object data that enables a three-dimensional representation of the tangible object to be rendered on the mobile device is obtained via the network, in response to a shopping selection. The three-dimensional representation of the tangible object is displayed with the graphical representation of the scene via the mobile device so that the appearance of the tangible object in the scene is simulated.

### FIELD OF THE INVENTION

This invention relates in general to computer interfaces, and more particularly to displaying network content on mobile devices.

### BACKGROUND OF THE INVENTION

The ubiquity of cellular phones and similar mobile electronics has led to demands for ever more advanced features in these devices. One feature that is of particular value in such devices is the ability to connect to the Internet and other networks. In near future, many aspects of the global networks such as the World Wide Web will be shifting to cater to mobile device users. Typically, mobile adaptations for Web content focused on dealing with the limited bandwidth, power, and display capabilities inherent in mobile devices. However, the fact that mobile devices can be used to provide data from wherever the user is located will provide additional opportunities to adapt Web content and increase the value of such content to the end user.

The always-on and always-connected nature of mobile devices makes them particularly useful in the context of commercial transactions. For example, some vending machines are configured so that a mobile phone user can purchase from the vending machine via the mobile phone. Tracking and billing of such transactions can be handled by the mobile phone service provider and third parties. These types of arrangements are useful to both merchants and consumers, because they provide alternate avenues of payment and thereby facilitate additional sales.

In addition to the properties described above, mobile phones are increasingly becoming multimedia devices. For example, it is becoming much more common for mobile phones to include an integrated camera. People are getting used to the fact they are carrying a camera with them, and can always snap a photo whenever they desire. Such devices may be able to capture video and sound and store it in a digitized format.

The ability of mobile devices to interact with the physical world of the user, as well as to interact remotely via networks, means that many new previously unimagined applications will emerge that combine these capabilities. In particular, commercial activities that effectively utilize the ability of a mobile device to determine facts about its current environment may be useful to vendors and service providers that operate via the Internet or other data networks.

### SUMMARY OF THE INVENTION

To overcome limitations in the prior art described above, and to overcome other limitations that will become apparent upon reading and understanding the present specification, the present invention discloses a system, apparatus and method for providing augmented reality assisted shopping via a mobile device.

In accordance with one embodiment of the invention, a method involves facilitating shopping for a tangible object via a network using a mobile device. A graphical representation of a scene of a local environment is obtained using a sensor of the mobile device. Graphical object data that enables a three-dimensional representation of the tangible object to be rendered on the mobile device is obtained via the network in response to a shopping selection. The three-dimensional representation of the tangible object with the graphical representation of the scene is displayed via the mobile device so that the appearance of the tangible object in the scene is simulated.

In more particular embodiment, the method involves facilitating user selection of a plurality of tangible objects and obtaining a plurality of graphical object data that enables a three-dimensional representation of the each of the plurality of tangible objects to be rendered on the mobile device. Each three-dimensional representation is displayed with the graphical representation of the scene so that the appearance of each of the plurality of tangible objects is simulated in the scene, one after another, in response to user selections.

In other, more particular embodiments, obtaining the graphical representation of the scene comprises capturing a still image via a camera of the mobile device and/or capturing a video data via a video camera of the mobile device. The graphic representation of the object may be updated based on changes in a camera view of the mobile device. In one arrangement, the tangible object includes a surface covering, and displaying the three-dimensional representation of the tangible object involves overlaying the three-dimensional representation on a surface detected in the scene.

In other, more particular embodiments, the method further involves sending the graphical representation of the scene to a service element via the network. In such an embodiment, obtaining the three-dimensional representation of the tangible object is facilitated in response to the sending of the representation of the scene. The embodiment may also further involve receiving geometry data of the scene from the service element via the network in response to sending the graphical representation of the scene. The geometry data assists the mobile device in accurately displaying the three-dimensional representation of the tangible object with the graphical representation of the scene. The embodiment may also further involve establishing a voice call with an operator with access to the service element. In such a case, the operator facilitates obtaining the three-dimensional representation of the tangible object in response to the sending of the representation of the scene. In another configuration, the method involves facilitating the purchase of the tangible object via the mobile device in response to a user selection of the graphical representation of the tangible object.

In another embodiment of the invention, a mobile device includes a sensor, a display, and a network interface capable of communicating via a network. A processor is coupled to the network interface, the sensor, and the display. A memory is coupled to the processor. The memory includes instructions that cause the processor to facilitate shopping for a tangible object via the network; obtain a graphical representation of a scene of a local environment using the sensor. The instructions further cause the processor to obtain, via the network, graphical object data that enables a three-dimensional representation of the tangible object to be rendered on the display. The graphical object data is obtained in response to a shopping selection. The instructions further cause the processor to present on the display the three-dimensional representation of the tangible object with the graphical representation of the scene so that the appearance of the tangible object in the scene is simulated.

In more particular embodiments, the instructions cause the processor to obtain the graphical object data in response to a selection of the tangible object made during the shopping via the mobile device. In one arrangement, the sensor includes a still camera, and obtaining the graphical representation of the scene involves capturing a still image via the still camera. In another arrangement, the sensor includes a video camera, and obtaining the graphical representation of the scene comprises involves a video image via the video camera. In this latter arrangement, the instructions may further cause the processor to update the three-dimensional representation of the tangible object on the display based on changes in a camera view of the mobile device. Also, the mobile device may include a location sensor, and in such a case the changes in the camera view are detected via the location sensor.

In other, more particular embodiments, the tangible object includes a surface covering, and the instructions further cause the processor to overlay the three-dimensional representation of the tangible object on a surface detected in the scene. In one arrangement, the instructions further cause the processor to send the graphical representation of the scene to a service element via the network and receive geometry data of the scene from the service element via the network in response to sending the graphical representation of the scene. The geometry data assists the mobile device in accurately displaying the three-dimensional representation of the tangible object within the graphical representation of the scene. In one arrangement, the instructions further cause the processor to facilitate a voice call between the mobile device and an operator via the service element, and the operator facilitates determining the geometry data.

In another embodiment of the invention, a computer-readable medium has instructions stored for performing steps that include facilitating shopping for a tangible object via the network using the mobile device; obtaining a graphical representation of a scene of a local environment using a sensor of the mobile device; obtaining, via the network, graphical object data that enables a three-dimensional representation of the tangible object to be rendered on the mobile device, wherein the graphical object data is obtained in response to a shopping selection; and displaying the graphic representation of the object with the graphical representation of the scene so that the appearance of the tangible object in the scene is simulated.

In another embodiment of the invention, a server includes a network interface capable of communicating via a network and a processor coupled to the network interface. A memory is coupled to the processor and includes instructions that cause the processor to receive a request for e-commerce data related to a tangible object from a mobile device that is shopping for the tangible object via the network. The instructions further cause the processor to determine, based on the request, graphical object data that enables a three-dimensional representation of the tangible object to be rendered on the mobile device, and send the e-commerce data and graphical object data to the mobile device so that the three-dimensional representation of the tangible object can be overlaid with a scene taken from a camera of the mobile device.

In more particular embodiments, the instructions further cause the processor to receive a graphical representation of the scene from the mobile device; determine geometry data of the scene that assists the mobile device in overlaying the three-dimensional representation of the tangible object with the scene, and send the geometry data to the mobile device via the network. In one arrangement, the instructions further cause the processor to facilitate a voice call between the mobile device and an operator, and the operator facilitates determining the geometry data of the scene that assists the mobile device in overlaying the three-dimensional representation of the tangible object with the scene.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described representative examples of systems, apparatuses, and methods in accordance with the invention.

### BRIEF DESCRIPTION OF THE DRAWINGS

The invention is described in connection with the embodiments illustrated in the following diagrams.

FIG. 1 is a block diagram of a system according to embodiments of the present invention;

FIG. 2 is a block diagram showing the placement of a graphical representation of a shopping object in a scene of mobile device display according to an embodiment of the invention;

FIG. 3 is a sequence diagram showing an example augmented reality assisted shopping scenario according to an embodiment of the invention;

FIG. 4A is a diagram of an augmented reality assisted shopping display using surface overlays according to an embodiment of the invention;

FIG. 4B is a diagram of an augmented reality assisted shopping display using replacement of an existing item in the environment according to an embodiment of the invention;

FIG. 5 is a perspective view and block diagram illustrating a dynamic augmented shopping scenario according to an embodiment of the present invention;

FIG. 6 is a perspective view illustrating a determination of fiducial points in the local environment according to an embodiment of the present invention;

FIG. 7 is a block diagram illustrating a representative mobile computing arrangement capable of carrying out operations in accordance with embodiments of the invention;

FIG. 8 is a block diagram illustrating an example system capable of providing augmented reality assisted shopping services according to embodiments of the present invention;

FIG. 9 is a block diagram illustrating a server capable of assisting in augmented reality assisted shopping services according to embodiments of the present invention; and

FIG. 10 is a flowchart showing a procedure for augmented reality assisted shopping according to an embodiment of the present invention.

### DETAILED DESCRIPTION OF EMBODIMENTS OF THE INVENTION

In the following description of various exemplary embodiments, reference is made to the accompanying drawings that form a part hereof, and in which is shown by way of illustration various embodiments in which the invention may be practiced. It is to be understood that other embodiments may be utilized, as structural and operational changes may be made without departing from the scope of the present invention.

Generally, the present invention involves merging data that is obtainable from a mobile transducer or sensor with graphical depictions of tangible objects that are obtained over a network. In one example, images available from a portable camera device are combined with network data in order to simulate the appearance of tangible goods in the local environment. A camera phone or similar device can be used to view a scene such as a room. Based on the contents of the image alone, and/or by using various sensors that may be embedded in the camera phone, the camera phone can determine the spatial orientation of the camera's viewfinder within the local environment. The device may also be able to search network data related to tangible objects (e.g., objects that the user wishes to purchase) that can be graphically represented in the scene. Network data that describes these objects can be combined with the spatial orientation and location data of the phone. This in effect simulates the appearance of the tangible object within the camera phone image, and provides the user with an indication of how the object might look if purchased and placed in the scene.

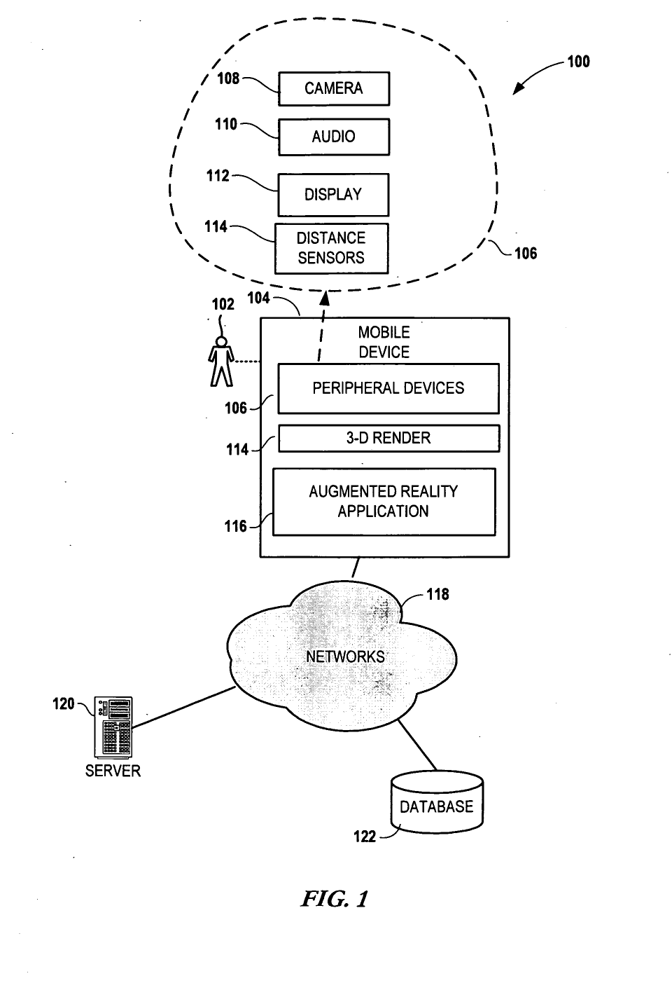

In reference now to FIG. 1, a system 100 according to embodiments of the present invention is illustrated. A user 102 has a mobile device 104 that may be used for any type of portable data communications. Typical mobile devices 104 include cellular phones and PDAs, but may also include laptop computers, portable music/video players, automotive electronics, etc. The functions of the mobile device 104 may also be included in apparatuses that are not typically mobile, such as desktop computers.

The mobile device may include any number of peripheral devices 106 for processing inputs and outputs. For example, the peripheral devices 106 may include a camera 108, audio equipment 110 (e.g., microphones and speakers), display 112 (e.g., LCD and LED displays), and a distance sensor 114. The distance sensor 114 may be, for example, an infrared receiver and emitter such as used on active camera autofocus mechanisms. A charged-coupled detector (CCD) of the digital camera 108 may also be used to assist in distance detection by the sensor 114. The distance sensing devices 114 may also include any combination of apparatus that enable the mobile device 104 to determine its absolute or relative position. Typical location sensing devices include GPS, digital compass/level, accelerometers, and proximity detectors (e.g., Radio Frequency ID tags, short-range radio receivers, infrared detectors).

The mobile device 104 contains functional modules that enable it to simulate the appearance of physical objects in the local environments as described herein. The mobile device 104 includes one or more applications 116 that are enabled to take advantage of the peripheral devices 106 in order to augment images or other data rendered via one or more of the peripheral devices 106. In particular, the applications 116 may be capable of accessing one or more networks 118 via wired or wireless network interfaces of the mobile device 104. The networks 118 may include any combination of private and public networks, and may range in size from small, ad hoc, peer-to-peer networks, to a global area network such as the Internet. Generally, the networks 118 provide network data services to the mobile device 104, as represented by the server 120 and database 122 that are accessible via the networks 118.

The data obtained at the mobile device 104 via the networks 118 may include any data known in the art, including text, images, and sound. Of particular interest in data that can be rendered in combination with digitized data obtained via peripheral devices 106. For example the data may include 3-D geometry, textures, and other descriptive data that allows representations of tangible objects to be rendered via a 3-D renderer 124 and presented on the display 112. These 3-D objects can be combined/overlaid with still or video images obtained via the peripheral devices 106 in order to simulate the object being present in the rendered image.

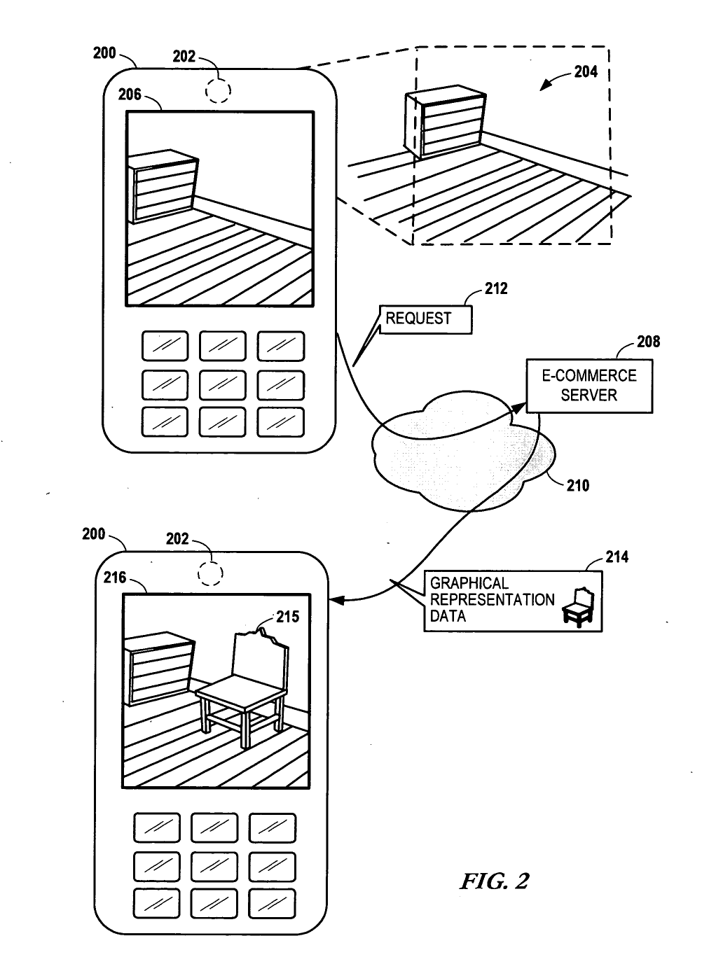

In reference now to FIG. 2, a simple use case according to an embodiment of the present invention is illustrated. The user points a camera 202 of a mobile phone 200 to a location in a room 204, which displays an image 206 in the phone's display that is representative of the camera view. In one implementation, the user accesses an e-commerce server 208 coupled to network 210 using a shopping application. The shopping application may have components that run locally on the phone 200 and/or remotely on the server 208. The shopping application allows the user to browse through various tangible items, such as chairs.

Part of this browsing involves sending requests 212 to the server 208 for graphical representations of the items currently being browsed through. In response, the server 208 provides graphical object data 214 that may be used to render a 3-D representation of the object on the phone 200. The graphical representation 214 may include any combination of bitmaps, vector data, metadata, etc., that allows a graphical representation 215 to be realistically displayed on the phone's display. The phone 200 superimposes the representation 215 on top of the camera view image 206 to form a composite image 216. The composite image 216 shows an approximation of how the chair would look like in the room 204 if it were purchased by the user.

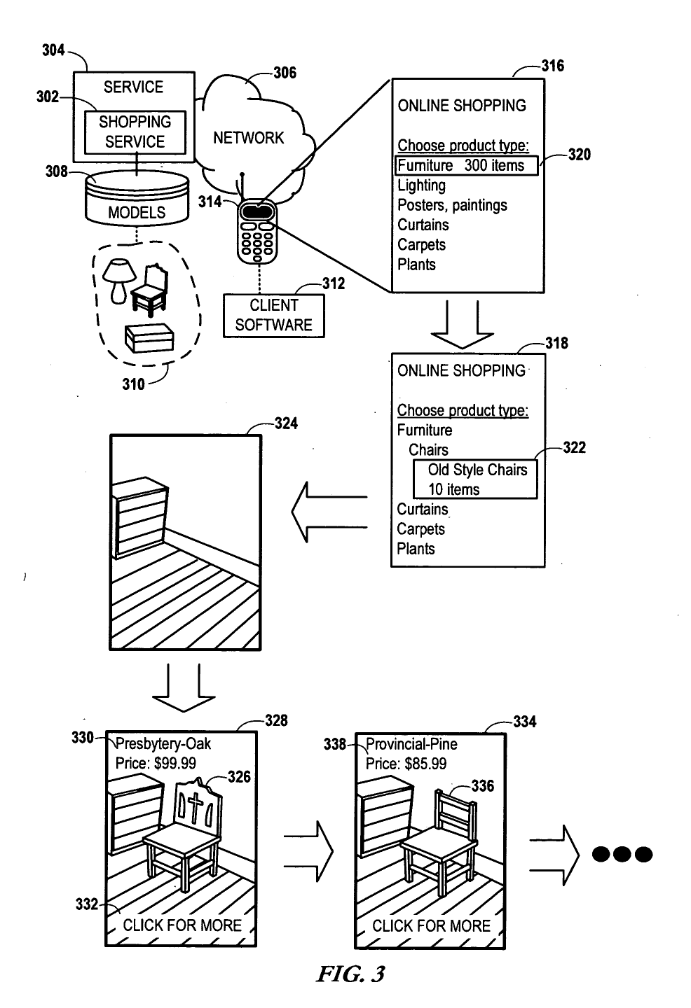

Additional implementation details of a use case according to an embodiment of the present invention are shown in FIG. 3. This use case involves an augmented shopping application as shown in FIG. 2. An online shopping service 302 runs on a remote server 304 that is accessible via a network 306 such as the Internet or a mobile services provider network. The service 302 has access to storage element 308 containing 3D models (or other graphical representations) of the tangible products 310 that are being sold. Possible product categories of tangible objects 310 include pieces of furniture, lamps, carpets, curtains, paintings, posters, plants, decorations, paints, wallpaper, doors, windows, automotive accessories, and so forth. The products 310 can be for indoor and outdoor use. The service 302 may also include a system for handling the cataloguing of products, pricing, handling orders, managing user accounts, secure ordering, and other e-commerce functions known in the art.

The shopping service 302 is accessed by client software 312 running on a mobile phone 314. The mobile phone 314 is equipped with the appropriate sensor, such as a video camera integrated with the device 314. The user connects with the client 312 to the shopping service 302 and browses through various products 310. The browsing may be performed through a conventional browser, such as illustrated by screens 316, 318. In screen 316, the user can select a number of product types, and in screen 318 the user can look at specific categories within a selected type. Note that the interface may include a description of the number of items available within selected types, as indicated by selection boxes 320 and 322. This may enable the user to determine whether the currently selected set of items is small enough to be browsed through using 3-D models 308.

When the user finds an interesting product or group of products, the user can turn on an “Augmented Reality Product Viewing Mode”. This means that the mobile phone's camera is activated so that it feeds a video/still image 324 showing whatever the user points the phone 314 towards. In particular, the user points the phone 314 towards the space where he would like to place the product or products for which he is shopping.

Based on the scene 324 captured via the phone 314, the client software 312 calculates the user's viewpoint to real world objects that are visible on the screen. This calculation of viewpoint may occur based on the graphics in the scene 324 itself, or may use additional sensors such as a distance sensor. When the viewpoint of the scene 324 is determined, one or more graphics objects 326 of products that the user is considering are downloaded via the network from the 3-D model database 308. The 3-D graphics object 326 is superimposed on the top of the video/still image 324, thus creating an augmented reality view 328.

The perspective and size of the 3-D graphics object 326 is made to match the perspective the user has to the real world through the video camera. Some of the modifications to the 3-D object 326 may be calculated based on the particular lens of the camera phone, detected light levels, etc. The lighting level and sources of the room can be applied to the 3-D object 326 to enhance the realism of the augmented view 328.

As will be discussed in greater detail hereinbelow, the client software 312 may be able to calculate the correct scales and perspective of the scene based on the image 324 alone. Nonetheless, calculating the correct size and perspective of the scene 324 may be subject to errors, particularly where the lighting is poor or there are few features in the scene 324 useful for calculating the scale of the scene 324. The client software 312 may have modes to help overcome this, such as having the user stand in a predetermined position relative to where the object is intended to be placed the scene 324 so that a reasonable first estimate of the size and perspective of the object 326 can be made. For example, the user may be instructed to stand in the spot where they wish the object to be placed, and then take a predetermined number of steps back, or move back a certain distance, say 2 meters. In another example, a well-known object may be placed where the user desires to place the object 326 in order to calibrate the scene. For example, a calibration marker such as a cardboard box with markings could be sent to the user and placed in an appropriate spot in the scene. In another scenario, an everyday object of consistent size (e.g., a yardstick, one liter soda bottle, cinder block, etc.) might be placed in the scene 324 and detected using image processing software. In either situation, because the dimensions of the object are already known, the scale of the scene 324 can be determined based on how the detected object is rendered in the camera view 324.

Even where a reasonable estimate of the scale of the scene 324 is made, the user may still be provided the option to manually change the size of the 3D object 326 to fit this object correctly to the real world. For example, the user may have the option to display a scale (e.g., ruler, grid, tick marks, etc) next to the object 326 so that the user can expand the scale along with the object 326 to provide a more accurate rendition in the augmented view 328. Similar controls may be provided for rotation, skew, perspective, color balance, brightness, etc.

The 3-D models 308 used to produce the 3-D object 326 are downloaded from the server 304 running the service 302. At the same time, information about each product may be sent as text data to the client 312 and rendered on the screen of the phone 314, such as product information text 330 shown in augmented view 328. The augmented view 328 might have other controls, such as controls that provide more textual information, and to rate, save, and/or purchase the product shown. The illustrated view 328 also includes a control 332 that allows the user to view another item from a collection of related items. Selecting this control 332 causes the display to show another augmented view 334, with a different object 336 and informational text 338. This process can continue for as many objects as the user would like to view.

Generally, a data connection (e.g., GPRS, WLAN) may be needed between the mobile terminal 314 and the remote server 304 offering the shopping service 302 at least for transferring graphical objects to the terminal 314. Many 3-D graphical modeling formats are capable of providing reasonably details objects using small file sizes. Thus, the implementation is feasible with existing technology, include formats (e.g., M3G, VRML) and mobile data transfer technologies (e.g., GPRS).

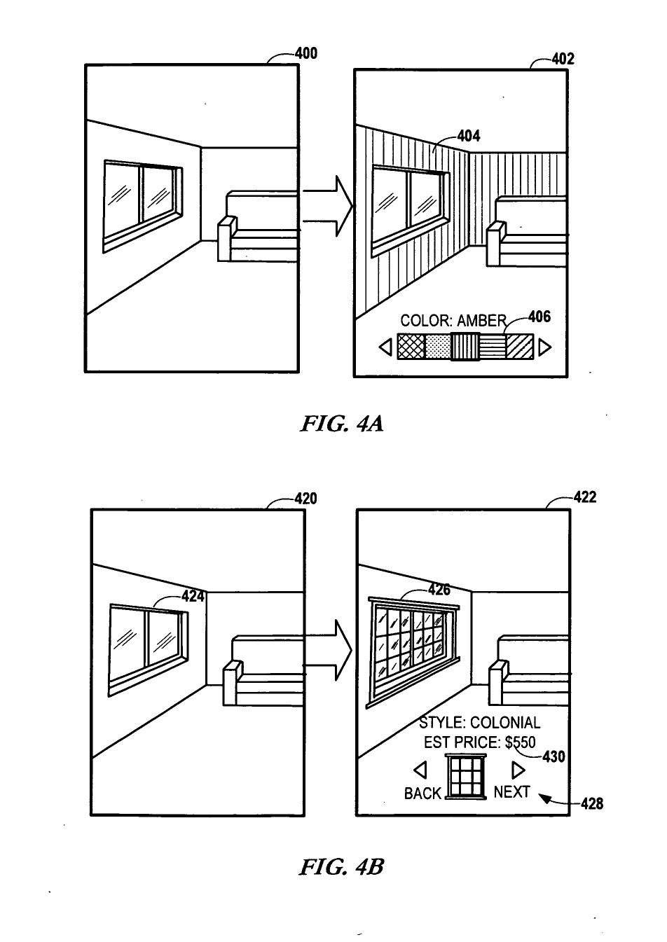

In the example of FIG. 3, an object is placed in a scene with a blank space, e.g., where the user would might like to place the object if the underlying tangible product were purchased. The graphical representation of the tangible object is rendered as if it were sitting in the blank space. This concept can also be applied to replacing or changing objects already in a scene, as shown in the example embodiments in FIGS. 4A and 4B. In FIG. 4A, an example scene 400 is rendered on a camera-equipped mobile device. The scene 400 is altered to create augmented scene 402 by changing the appearance of one or more surfaces, in this example a wall 404. The appearance of the surface 404 may be selected and altered by way of a menu 406 that is provided, for example, by a wallpaper or paint supplier. The supplier need not supply a 3-D model, but merely some combination of color, pattern, and texture that can be overlaid on objects in the scene 402.

In FIG. 4A, a digitally captured scene 420 is altered to created augmented scene 422 by replacing one or more objects in the original scene 420. In this example, real window 424 in scene 420 is replaced by simulated window 426 in scene 422. The user may be able to replace the virtual window 426 using menu controls 428. Informational text 430 may also be displayed describing the currently displayed object 426. It will be appreciated that the virtual device rendering shown in FIG. 4B may involve both rendering virtual 3-D objects in the scene 422 (e.g., window ledges) and overlaying surface effects so that they appear to follow the contour of a real element in the scene (e.g., rendering window panes over the glass as a surface feature).

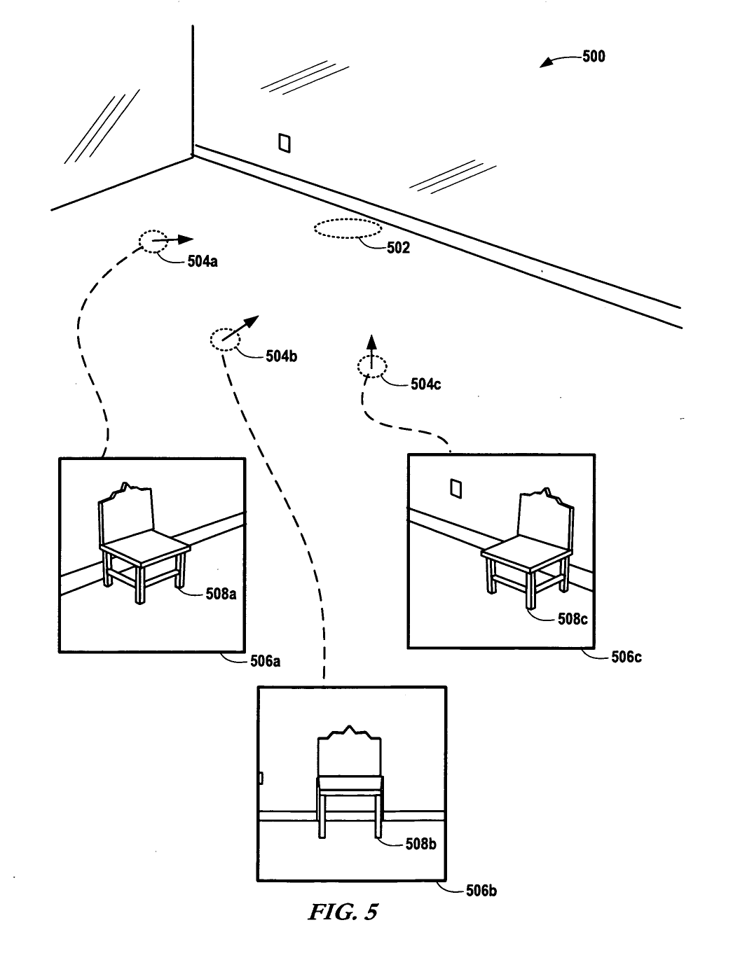

One advantage gained from rendering virtual objects in the display of a mobile device is that the user may be able to view the virtual objects from a number of angles in the local environment. An example of this is shown in the diagram of FIG. 5, which illustrates an example of dynamic rendering of objects according to an embodiment of the invention. In this example, the user is taking images from within a room 500 using a mobile device that has the appropriate sensors, including a camera for capturing images from the room 500. A location 502 in the room is chosen for placing a possible object for purchase. Using various techniques described herein elsewhere, a graphical representation of the object is overlaid on a display of the camera view of the room 500 so that it appears the object is located in the desired location 502.

As the user moves around the room 500, as represented by locations 504a-c, the scene in the device display changes, as represented by screens 506a-c. Accordingly, the appearance of the object will also need to change, as represented by graphical representations 508a-c. In this way, the user can have a more accurate feel for how the object will look in the room 500 than can be communicated using a single view. The composite image seen in screens 506a-c could be individual snapshots, or be example scenes from a continuous video stream taken from the device's camera.

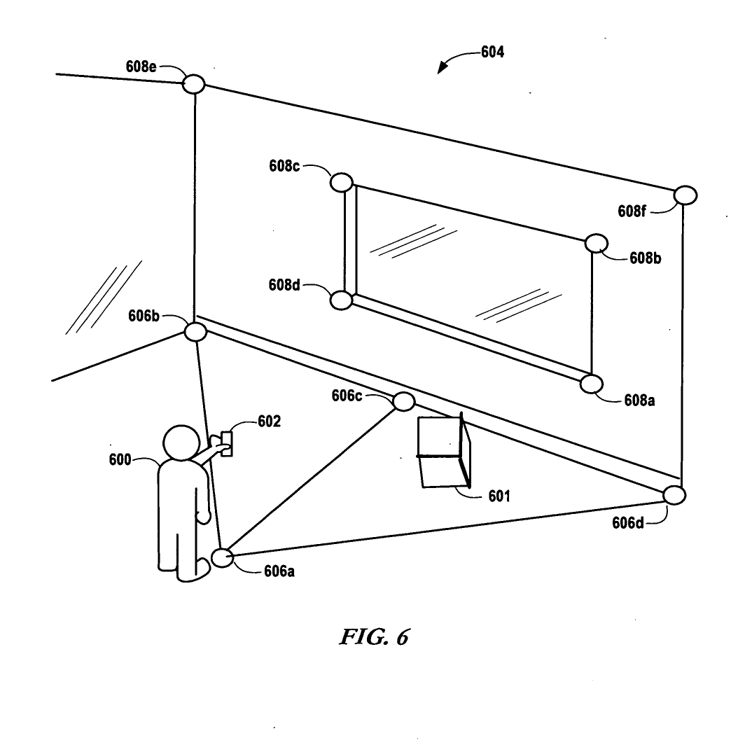

It will be appreciated that, in order for the different views 506a-c to be generated, a device may need to be aware of its location and orientation. In particular, a device may as least need to know its locations relative to reference points in the room 500 or other points of interest. The device may also need to know angles of orientation relative to the earth's surface, often defined as tilt or pitch/roll angles. Alternatively, the device may be able to make an estimate of how to render a virtual object from different vantage points based on clues contained in the images 506a-c themselves, in which case sensor information that determines location and orientation may not needed. In reference now to FIG. 6, an example is illustrated of setting up a device to be aware of how to realistically depict an object in a locally rendered scene according to embodiments of the invention.

In FIG. 6, a user 600 is utilizing a mobile device 602 for purposes of viewing virtual objects in a depiction of a room 604. In one example, the device 602 is able to determine the perspective, tilt, and scale in which to place an image based on the image itself. Generally, as used herein, the term “perspective” may be applied to describe the total geometric properties needed to describe how a camera image relates to the real world object the image depicts. These geometric properties may include, but are not limited to, relative locations and angles between the camera and real world objects, curvature and depth of field effects caused by camera lens geometry, etc.

An example of how the perspective of an image can be determined based solely on the image is described in “Calibration-free Augmented Reality,” by Miriam Wiegard, OE Magazine, July 2001. The calibration-free method utilizes a colored marker 601 that may be formed, for example, from three orthogonal planar members joined to resemble a Cartesian coordinate axis in three-space. The marker 601 may resemble three interior sides of a box with colored stripes along each of the three edges formed by intersecting planes. The colored stripes representation the x-, y-, and z-axes. Each of the x-, y- and z-axes is a different color, typically selected from red, green, and blue. Other indicia may also be placed on the planar members, such as colored dots. Together, the axes and indicia on the marker 601 act as fiducials that allow the device's viewing geometry to be determined.

The user 600 places the marker 601 at an appropriate point in the room 604, such as where the user 600 desires the virtual object to be rendered. A camera of the device 602 is pointed at the marker 601. Client software on the device 602 detects the change in red, green and blue levels in the image and determines the size and orientation of the marker 601 relative to the device 602. This allows the device 602 to determine the angles and distances between the device 602 and the marker 601, and can use this geometric data to render a virtual object in the display with the correct perspective.

As an alternate to using a single marker 601, the device 602 may be enable the user to use three or more reference points 606a-d, 608a-f within the room as fiducial points. In the illustrated example, the reference points 606a-d, 608a-f may be located at corner and/or edge features of the room, although other points of interest may also be used as a reference point. In order to determine these reference points 606a-d, 608a-f in the current image, the image display of the device 602 may include a selector and graphical tools that allows the user 600 to pick the location of the reference points 606a-d, 608a-f directly from the display of the room device's screen. The user 600 may need to input data describing the relative location of the points, or the device 602 may have sensors that can detect these distances. Alternatively, the user 602 may use separate tool, such as a laser pointer, to highlight the location of the reference points 606a-d, 608a-f in a way that is automatically detectable by the camera or other sensor on the device. Other tools that may aid in fiducial determination may include radio or infrared transponders, radio frequency identification (RFID) tags, sound emitters, or any other device that can be remotely detected by a sensor on the device 602.

Where the correct perspective for virtual objects is determined based only on a marker 601 or other fiducial marks 606a-d, 608a-f, the marker 601 or fiducials may need to remain in place and detectable as the device 602 is moved around the room 604. Alternatively, the device 602 may include sensors (e.g., accelerometers, motion sensors, distance sensors, proximity sensors) that enable the device to detect changes in locations. Therefore, the device 602 may be able to determine its initial bearings based on the marker 601, and update the location data based on detected movements relative to the starting point.

Where the device 602 is able to determine its location, either absolute or relative, other methods may be feasible to determine the correct perspective in which to render virtual objects without using camera imagery (or in addition to using the camera imagery). For example, using the mobile device 602, the user 600 may be able to map out the various reference points 606a-d, 608a-f by placing the device 602 in each of these locations, and having the device 602 remember the location. The device 602 may determine the location of the reference points 606a-d, 608a-f automatically, or may be partially or wholly guided by the user 600. For example, the device 602 may include geolocation and compass software (e.g., GPS, inertial navigation) that allows the device 602 to know its current location and bearing. The user 600 may just move the device 602 to each of the reference points 606a-d, 608a-f and press an input button on the device 602 to mark the location. The user 600 may provide additional input during such data entry, as to what physical object the reference points 606a-d, 608a-f belong (e.g., wall, window, etc.) and other data such as elevation. For example, points 606d and 606f may be input at the same time, just by entering the location twice but with different elevations.

Generally, the use of markers 601 or reference points 606a-d, 608a-f enable the device 602 to correlate images seen through a device camera with features of the real world. This correlation may be achieved using geometric data that describes features of the camera view (e.g., lens parameters) as well as local environmental variables (e.g., distances to feature of interest). It will be appreciated that a device 602 according to embodiments of the invention may use any combination of location sensing, distance sensing, image analysis, or other means to determine this geometric data, and are not dependent any particular implementation. Assuming that the device 602 can derive geometric data that describes the local environment, then the device 602 can superimpose graphical objects and overlays in the image so that a realistic simulation of the tangible objects of interest can be presented to the user. The manipulation of 3-D objects in a display based on features of the camera view and local environment is well known in the art, and a description of those algorithms may be found in references that describe 3-D graphics technologies such as OpenGL and Direct3D.

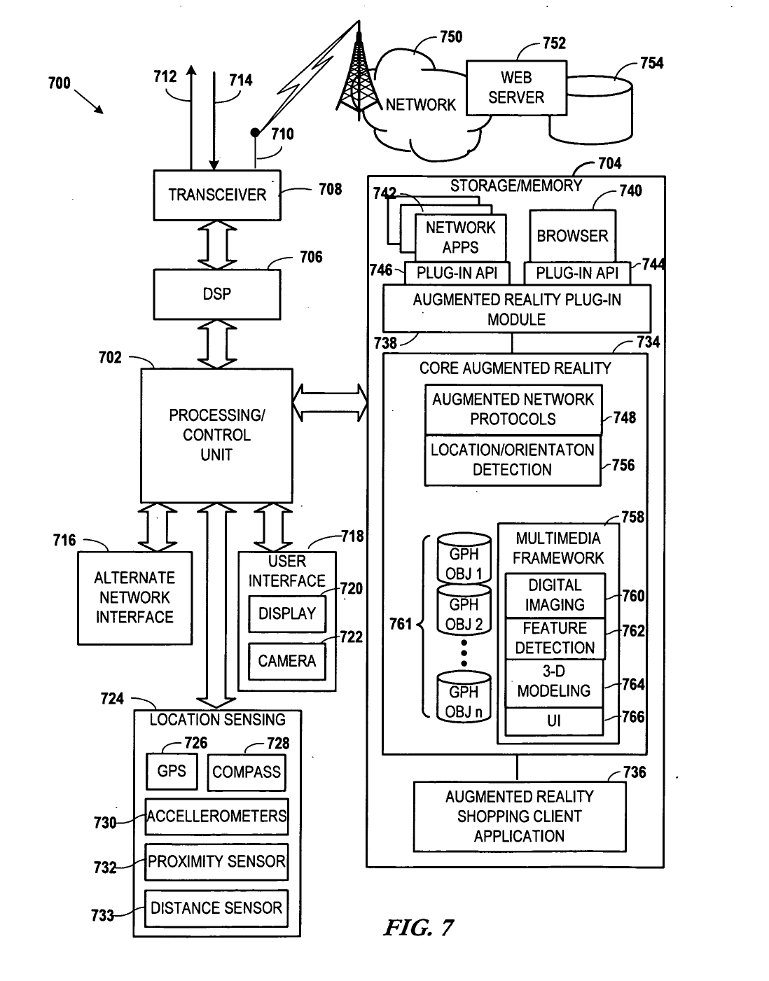

Many types of apparatuses may be able to operate augmented reality client applications as described herein. Mobile devices are particularly useful in this role. In reference now to FIG. 7, an example is illustrated of a representative mobile computing arrangement 700 capable of carrying out operations in accordance with embodiments of the invention. Those skilled in the art will appreciate that the exemplary mobile computing arrangement 700 is merely representative of general functions that may be associated with such mobile devices, and also that landline computing systems similarly include computing circuitry to perform such operations.

The processing unit 702 controls the basic functions of the arrangement 700. Those functions associated may be included as instructions stored in a program storage/memory 704. In one embodiment of the invention, the program modules associated with the storage/memory 704 are stored in non-volatile electrically-erasable, programmable read-only memory (EEPROM), flash read-only memory (ROM), hard-drive, etc. so that the information is not lost upon power down of the mobile terminal. The relevant software for carrying out conventional mobile terminal operations and operations in accordance with the present invention may also be transmitted to the mobile computing arrangement 700 via data signals, such as being downloaded electronically via one or more networks, such as the Internet and an intermediate wireless network(s).

The mobile computing arrangement 700 includes hardware and software components coupled to the processing/control unit 702 for performing network data exchanges. The mobile computing arrangement 700 may include multiple network interfaces for maintaining any combination of wired or wireless data connections. In particular, the illustrated mobile computing arrangement 700 includes wireless data transmission circuitry for performing network data exchanges.

This wireless circuitry includes a digital signal processor (DSP) 706 employed to perform a variety of functions, including analog-to-digital (A/D) conversion, digital-to-analog (D/A) conversion, speech coding/decoding, encryption/decryption, error detection and correction, bit stream translation, filtering, etc. A transceiver 708, generally coupled to an antenna 710, transmits the outgoing radio signals 712 and receives the incoming radio signals 714 associated with the wireless device.

The mobile computing arrangement 700 may also include an alternate network/data interface 716 coupled to the processing/control unit 702. The alternate network/data interface 716 may include the ability to communicate on secondary networks using any manner of data transmission medium, including wired and wireless mediums. Examples of alternate network/data interfaces 716 include USB, Bluetooth, Ethernet, 802.11 Wi-Fi, IRDA, etc. The processor 702 is also coupled to user-interface elements 718 associated with the mobile terminal. The user-interface 718 of the mobile terminal may include, for example, a display 720 such as a liquid crystal display and a camera 722. Other user-interface mechanisms may be included in the interface 718, such as keypads, speakers, microphones, voice commands, switches, touch pad/screen, graphical user interface using a pointing device, trackball, joystick, etc. These and other user-interface components are coupled to the processor 702 as is known in the art.

Other hardware coupled to the processing unit 702 may include location sensing hardware 724. Generally, the location sensing hardware 724 allows the processing logic of the arrangement 700 to determine absolute and/or relative location and orientation of the arrangement 700, including distances between the arrangement 700 and other objects. The location may be expressed in any known format, such as lat/lon and UTM. The orientation may be expressed using angles of a component of the arrangement (e.g., lens of the camera 722) relative to known references. For example, pitch and roll measurements may be used to define angles between the component and the earth's surface. Similarly, a heading measurement may define an angle between the component and magnetic north. The location sensing hardware 724 may include any combination of GPS receivers 726, compasses 728, accelerometers 730, and proximity sensors 732, distance sensors 733, and any other sensing technology known in the art.

The program storage/memory 704 typically includes operating systems for carrying out functions and applications associated with functions on the mobile computing arrangement 700. The program storage 704 may include one or more of read-only memory (ROM), flash ROM, programmable and/or erasable ROM, random access memory (RAM), subscriber interface module (SIM), wireless interface module (WIM), smart card, hard drive, or other removable memory device. The storage/memory 704 of the mobile computing arrangement 700 may also include software modules for performing functions according to embodiments of the present invention.

In particular, the program storage/memory 704 includes a core functionality module 734 that provides some or all of the augmented reality client functionality as described hereinabove. The core functionality 734 may be used by a standalone augmented reality assisted shopping client application 736. The core functionality 734 may also be provided as a plug-in module 738. The plug-in module 738 may be used to extend the functionality of other applications such as a browser 740 or other networking applications 742. These applications 740, 742 have respective generic plug-in interfaces 744, 746 that allow third parties to extend the functionality of the core application 740, 742.

The core functionality module 732 may include an augmented reality network protocol module 748 that allows the arrangement 700 to download, upload, search for, index, and otherwise process network content that includes object models that may be used in local simulations. These object models may be exchanged with other entities via a network 750. The object models may be provided, for example by a Web server 752 and/or network accessible database 754. The augmented network protocol module 748 may also determine locations of the arrangement 700 via a location/orientation module 756. The location/orientation module 756 is adapted to detect locations and orientations from location sensing hardware 724 and/or camera imagery, and perform transformations in order to present location and orientation information into a common format for other components of the core functionality module 734. The location/orientation module 756 may also detect, calculate, and store information that describes various user environments where mapping of 3-D models/surfaces onto digital images is desired.

In some configurations, the orientation of the camera 722 and the environmental information (e.g., location of structures, objects, etc.) may be obtained in whole or in part by analyzing the image data itself. This is represented by the feature detection module 762 which is part of a multimedia framework 758. The feature detection module 762 detects fiducial features (e.g., via markers in the image) from digital camera images and translates those features into geometric data descriptive of the local environment and camera parameters.

The multimedia framework module 758 typically includes the capability to utilize geometric data relevant to the local environment and use that data to render graphical representations of data These functions of the multimedia framework module 758 can be used to display graphical representations of tangible object on images in real-time or near-real-time via the user interface hardware 718. For example, a digital imaging module 760 may be able to capture images via the camera 722 and display the images in the display 720. These images can be overlaid with one or more graphical objects 761 that may, for example, correspond to results of network data searches conducted via the network protocol module 748. The imaging module 760 can determine the correct distances and perspectives of the image from the location detection module 756 and/or the feature detection module 762. The overlay of the graphical objects 761 may also involve participation by 3-D modeling libraries 764 (e.g., OpenGL, Direct3D, Java3D, etc). The local geometric data can be used by the imaging module 760 to alter the display parameters of the 3-D models via API calls to the modeling libraries 764. The display parameters of the models may also be modified by a UI 766 component, which allows users to select, rotate, translate, and scale rendered objects as desired. The UI 766 may also allow the user to interact with other modules. For example, user inputs may be needed for operation of the feature detection module 762 in order to assist in resolving anomalies when attempting to detect features.

The mobile computing arrangement 700 of FIG. 7 is provided as a representative example of a computing environment in which the principles of the present invention may be applied. From the description provided herein, those skilled in the art will appreciate that the present invention is equally applicable in a variety of other currently known and future mobile and landline computing environments. For example, desktop computing devices similarly include a processor, memory, a user interface, and data communication circuitry. Thus, the present invention is applicable in any known computing structure where data may be communicated via a network.

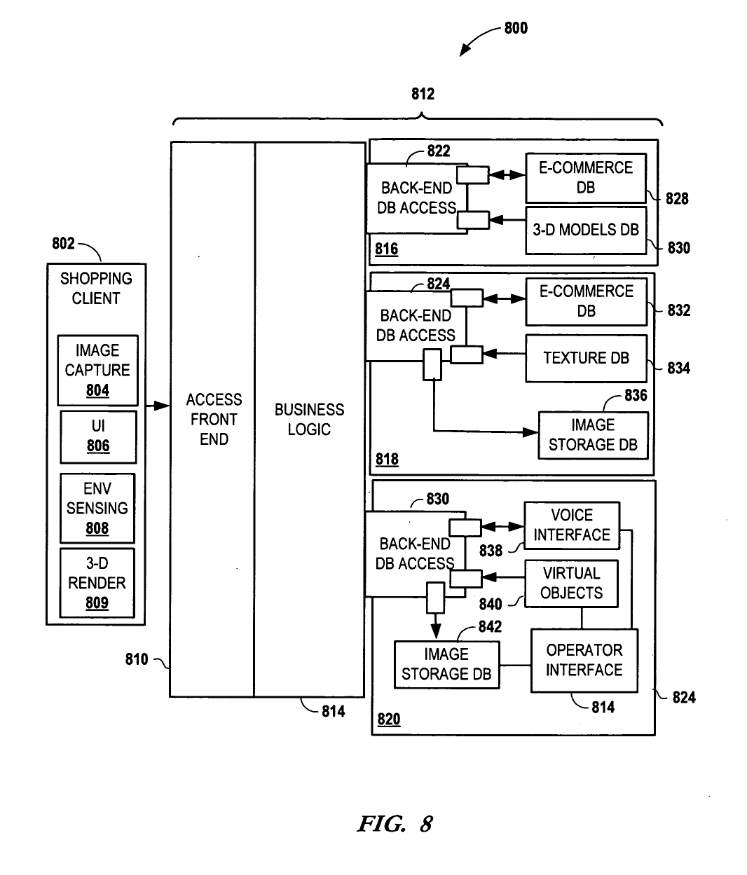

The augmented reality assisted shopping applications running on a terminal may be able to find virtual objects to display in the local environment using standard search engine techniques. For example, a search engine may be able to search for keywords from e-commerce Web pages, and find files in the formats supported by the locally running application. However, a more convenient way for a user to look for tangible objects that have associated objects for use in augmented reality assisted shopping is to provide a single front end that provides a wide variety of shopping choices, typically from multiple vendors that are all compatible with the augmented reality formats and protocols. In reference now to FIG. 8, a system 800 is illustrated that may be implemented to provide a unified augmented shopping experience according to embodiments of the invention.

Generally, the system 800 may provide an enhanced virtual shopping experience for user with specialized client applications 802. These applications 802 may be built on existing application frameworks (e.g., browsers, multimedia software) or be custom tailored applications. Generally, the client applications 802 may include an image capture function 804 to obtain real-time or near-real-time images of the local environment in which tangible items are to be simulated. A user interface (UI) 806 provides access to image capture functions 804 (including display of captured and composite images), as well as allowing the user to search for and select objects for simulation in the environment. An environmental sensing module 808 provides data describing distances and locations in the local environment. This data may be used by a 3-D rendering module 809 that processes modeling data and facilitates rendering of the models via the UI 806.

The client applications 802 are capable of accessing a uniform front end interface 810 of an augmented reality provider infrastructure 812. Generally, the front end 810 is a uniform and generic interface that allows data relating to augmented reality to be sent from and received by the shopping clients 802. A back-end business logic layer 814 interfaces with a variety of service providers 816, 818, 820 that may provide services such as online shopping and online assistance.

The service providers 816, 818, 820 utilize individualized backend database interfaces 822, 824, and 826. These database interfaces 822, 824, 826 translate between the business logic layer 814 of the infrastructure 812 and the individualized databases and services of the providers 816, 818, 812. For example, provider 816 may include a standard e-commerce database 828 that includes such data as pricing, part numbers, availability, ratings, description, images, etc. A 3-D models database 830 may be linked or otherwise associated with the e-commerce database 828. Generally, the 3-D models database 830 has data that can be used to provide data objects for creating 3-D renderings of tangible objects that are being sold via the e-commerce database 828.

The second example service provider 818 has an e-commerce database 832 that may provide data similar to the first provider's database 828. The second provider 818, however, has a textures database 834 that may be used to provide various colors, patterns, surface maps, etc., that can be applied to objects in an image. The provider 818 also has a database 836 that may be used to store images provided from the users of the clients 802. This database 836 might be used, for example, to allow server-side processing of some aspects of the virtual reality modeling. The client 802 may submit images taken from the image capture 804 where it is processed.

In other arrangements, the client 802 may send both images and 3-D modeling representations of the environment shown in the images, and this data can be stored in the database 836. For example, the client 802 may do local processing to determine the 3-D geometric parameters of the space depicted in the image, and may present a model and data associated with the image (e.g., reference points that tie parts of the images with the model). In this way, the provider 818 may be able to provide future services based on the data in the database 836. For example, the purchaser of a new home may use the client 802 to choose some items such as draperies. Later, the user may use the client 802 in association with another purchase such as furniture. The provider 836 may be able to provide recommendations based on the stored data, and prepare a list of furniture that will both fit the room and match the drapes.

The third provider 820 may take advantage of the voice communications capability of a mobile device (e.g., cell phone) that runs the client 802. This provider 820 has a voice interface 838 that might be connected to an operator switchboard or PBX. The voice interface 838 may be associated with an autodialer function (not shown) included with the clients 802. The provider 820 also includes a virtual objects database 840 that may provide 3-D models, surface maps, or other imagery data. An image storage database 842 may store imagery and data collected via the client 802. An operator interface 844 ties together these functions 838, 840, 842 to allow a human operator to assist in rendering objects and otherwise providing shopping assistance. For example, the client UI 806 may have an option that says “Select to talk to an operator about these products.” When selected, the user device is connected to the service provider 820. From there, the operator can discuss what the user is looking for, instruct the user (either by voice or via the client software 802) to capture the requisite images. Those capture images can then be sent via the client 802 to the image database 842. The operator may be able to process the imagery for the user using local processors and software, thereby offloading at least some of the image processing from the client 802. Based on the conversations with the user and the acquired data, the operator may be able create a subset of objects from the database 840 that seem to fit the customer's needs, and send them to the client 802 for review. The user may be able to render these or other objects in the client application 802 without further assistance, or may stay on line to discuss it further. Preferably, even where some of the image processing is performed remotely, the client 802 includes some way of locally modifying the appearance of the virtual objects in the UI 806 when the camera is moved, thereby providing the advantages of augmented reality.

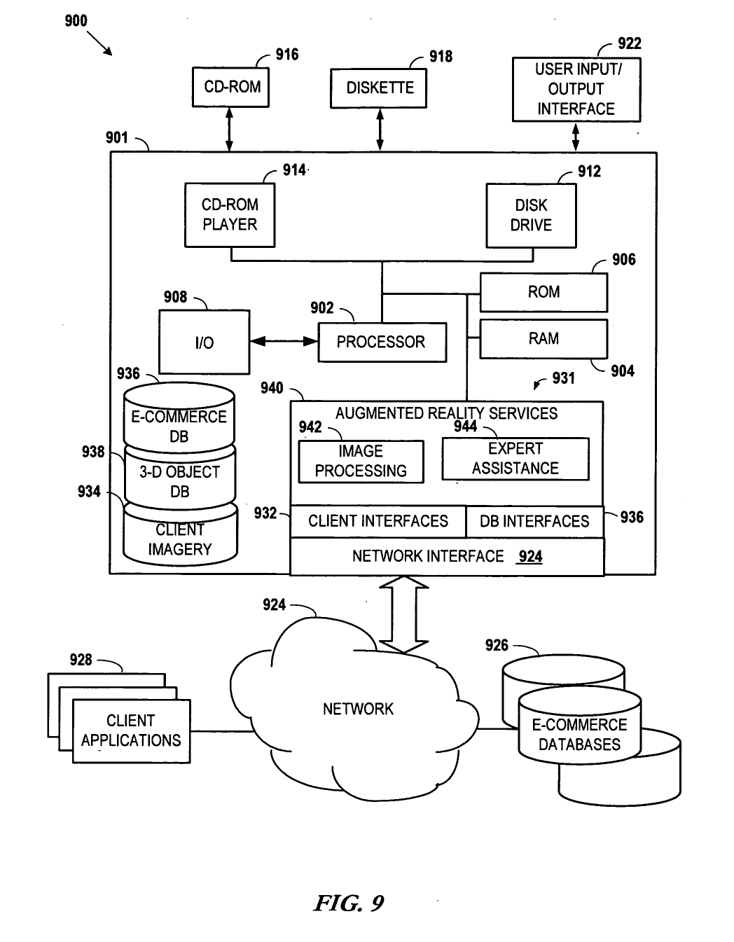

As described hereinabove, one or more network components may centralize and standardize various types of object data (models) used for augmented reality assisted shopping. This object data can be delivered to mobile devices in order to locally render representations of tangible items in the user's local environment of a mobile device user. These network components may provide other functions related to the augmented shopping experience, such as providing expert assistance and offloading some or all of the image processing. FIG. 9 shows an example computing structure 900 suitable for providing augmented reality assistance services according to embodiments of the present invention.

The computing structure 900 includes a computing arrangement 901. The computing arrangement 901 may include custom or general-purpose electronic components. The computing arrangement 901 includes a central processor (CPU) 902 that may be coupled to random access memory (RAM) 904 and/or read-only memory (ROM) 906. The ROM 906 may include various types of storage media, such as programmable ROM (PROM), erasable PROM (EPROM), etc. The processor 902 may communicate with other internal and external components through input/output (I/O) circuitry 908. The processor 902 carries out a variety of functions as is known in the art, as dictated by software and/or firmware instructions.

The computing arrangement 901 may include one or more data storage devices, including hard and floppy disk drives 912, CD-ROM drives 914, and other hardware capable of reading and/or storing information such as DVD, etc. In one embodiment, software for carrying out the operations in accordance with the present invention may be stored and distributed on a CD-ROM 916, diskette 918 or other form of media capable of portably storing information. These storage media may be inserted into, and read by, devices such as the CD-ROM drive 914, the disk drive 912, etc. The software may also be transmitted to computing arrangement 901 via data signals, such as being downloaded electronically via a network, such as the Internet. The computing arrangement 901 may be coupled to a user input/output interface 922 for user interaction. The user input/output interface 922 may include apparatus such as a mouse, keyboard, microphone, touch pad, touch screen, voice-recognition system, monitor, LED display, LCD display, etc.

The computing arrangement 901 may be coupled to other computing devices via networks. In particular, the computing arrangement includes a network interface 924 for interacting with other entities, such as e-commerce databases 926 and client applications 928 (e.g., mobile terminal software) via a network 930. The network interface 924 may include a combination of hardware and software components, including media access circuitry, drivers, programs, and protocol modules.

The computing arrangement 901 includes processor executable instructions 931 for carrying out tasks of the computing arrangement 901. These instructions include client interfaces 932 capable of communicating with client applications 928. The client interfaces 932 are generally capable of receiving search queries from the clients 928, sending search results (including models and metadata) to the clients 928, determining client capabilities and locations, etc. The client interfaces 932 may interface with a client imagery database 934 for storing data related to client interactions 928, including images captured from the clients 928, preferences, location and object data describing the local environment of the clients 928, etc.

The computing arrangement 901 may also include object and e-commerce databases 936, 938 capable of respectively storing e-commerce data and object models related to tangible items available by the e-commerce database 938. The e-commerce data and object data could be stored entirely on the local databases 936; 938, on external databases 926, or any combination thereof. Even where all the e-commerce and object data is stored on external databases 926, the internal databases 936, 938 may be used at least to cache frequently accessed data.

One or more augmented reality assistance services 940 may control communications between the client applications 928 and other components of the computing structure 900. The augmented reality assistance services 940 may perform typical e-commerce functions, including receiving queries and, in response the queries, provide results that include modeling data 938 for the client applications 928. The augmented reality assistance services 940 may provide other specific functions relating to augmented reality assisted shopping, including image processing 942 and expert assistance 944.

The image processing service 942 may offload some of the processor intensive tasks need to determine the correct sizes and perspectives the client devices 928 based on features in client imagery 934. For example, the image processing service 942 may receive 2-D camera images in the form of multimedia messaging system (MMS) message or the like and determine the relative location and sizes of boundaries and other objects in the images. Location coordinates or other 3-D geometry data could be returned to the clients 928 in response to the MMS. This geometry data could be linked with features of the image (e.g., pixel locations) so that the client applications 928 can independently render objects 938 in the image without further assistance from the service 942.

The expert assistance service 944 may provide context specific assistance to the users of the client applications 928, either through connection to human experts or by intelligent software. This assistance may be related to the image processing functions that occur either at the client applications 928 or at the image processing service 942. The expert assistance service 944 may also provide other manners of assistance based on the contents of images sent to the imagery database 934. For example, image computations that determine size, weight, color, environmental factors, etc., may be derived from the images 934 and be used to better narrow choices that are offered to the users by way of the client applications 928.

The computing structure 900 is only a representative example of network infrastructure hardware that can be used to provide location-based services as described herein. Generally, the functions of the computing structure 900 can be distributed over a large number of processing and network elements, and can be integrated with other services, such as Web services, gateways, mobile communications messaging, etc.

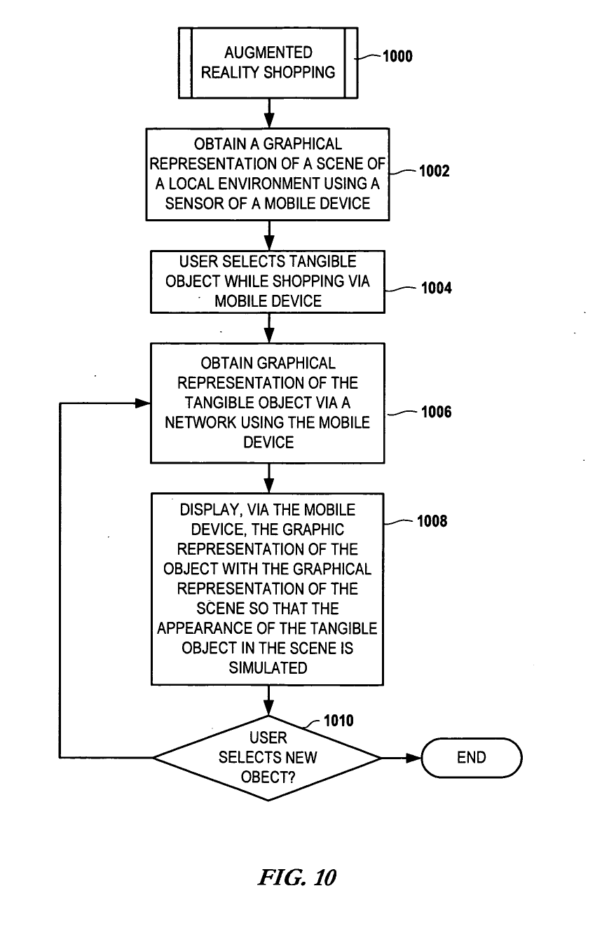

In reference now to FIG. 10, a flowchart illustrates a procedure 1000 for augmented reality assisted shopping in accordance to an embodiment of the invention. A user obtains 1002 a graphical representation of a scene of a local environment using a sensor of a mobile device. The user selects 1004 a tangible object while shopping via the mobile device, typically selecting the object via a network service. A graphical representation of a tangible object is obtained 1006 via a network using the mobile device, and the graphic representation of the object is displayed 1008 with the graphical representation of the scene so that the appearance of the tangible object in the scene is simulated. The user may select 1010 additional objects, in which case the process of obtaining 1006 and displaying 1008 the additional objects continues.

The foregoing description of the exemplary embodiments of the invention has been presented for the purposes of illustration and description. It is not intended to be exhaustive or to limit the invention to the precise form disclosed. Many modifications and variations are possible in light of the above teaching. It is intended that the scope of the invention be limited not with this detailed description, but rather determined by the claims appended hereto.

What is claimed is:

1. A method comprising:
facilitating shopping for a tangible object via a network using a mobile device;
obtaining a graphical representation of a scene of a local environment using a sensor of the mobile device;
obtaining, via the network, graphical object data that enables a three-dimensional representation of the tangible object to be rendered on the mobile device, wherein the graphical object data is obtained in response to a shopping selection; and
displaying, via the mobile device, the three-dimensional representation of the tangible object with the graphical representation of the scene so that the appearance of the tangible object in the scene is simulated.

2. The method of claim 1, further comprising:
facilitating user selection of a plurality of tangible objects;
obtaining a plurality of graphical object data that enables a three-dimensional representation of each of the plurality of tangible objects to be rendered on the mobile device;
displaying each three-dimensional representation with the graphical representation of the scene so that the appearance of each of the plurality of tangible objects is simulated in the scene, one after another, in response to user selections.

3. The method of claim 1, wherein obtaining the graphical representation of the scene comprises capturing a still image via a camera of the mobile device.

4. The method of claim 1, wherein obtaining the graphical representation of the scene comprises capturing a video data via a video camera of the mobile device.

5. The method of claim 4, further comprising updating the graphic representation of the object based on changes in a camera view of the mobile device.

6. The method of claim 1, wherein the tangible object comprises a surface covering, and wherein displaying the three-dimensional representation of the tangible object comprises overlaying the three-dimensional representation on a surface detected in the scene.

7. The method of claim 1, further comprising sending the graphical representation of the scene to a service element via the network, and wherein obtaining the three-dimensional representation of the tangible object is facilitated in response to the sending of the representation of the scene.

8. The method of claim 7, further comprising receiving geometry data of the scene from the service element via the network in response to sending the graphical representation of the scene, wherein the geometry data assists the mobile device in accurately displaying the three-dimensional representation of the tangible object with the graphical representation of the scene.

9. The method of claim 7, further comprising establishing a voice call with an operator with access to the service element, and wherein the operator facilitates obtaining the three-dimensional representation of the tangible object in response to the sending of the representation of the scene.

10. The method of claim 1, further comprising facilitating the purchase of the tangible object via the mobile device in response to a user selection of the graphical representation of the tangible object.

11. A mobile device comprising:
a sensor;
a display;
a network interface capable of communicating via a network;
a processor coupled to the network interface, the sensor, and the display; and
a memory coupled to the processor, the memory including instructions that cause the processor to,
facilitate shopping for a tangible object via the network;
obtain a graphical representation of a scene of a local environment using the sensor;
obtain, via the network, graphical object data that enables a three-dimensional representation of the tangible object to be rendered on the display, wherein the graphical object data is obtained in response to a shopping selection; and
present on the display the three-dimensional representation of the tangible object with the graphical representation of the scene so that the appearance of the tangible object in the scene is simulated.

12. The mobile device of claim 11, wherein the instructions cause the processor to obtain the graphical object data in response to a selection of the tangible object made during the shopping via the mobile device.

13. The mobile device of claim 11, wherein the sensor comprises a still camera, and wherein obtaining the graphical representation of the scene comprises capturing a still image via the still camera.

14. The mobile device of claim 11, wherein the sensor comprises a video camera, and wherein obtaining the graphical representation of the scene comprises capturing a video image via the video camera.

15. The mobile device of claim 14, wherein the instructions further cause the processor to update the three-dimensional representation of the tangible object on the display based on changes in a camera view of the mobile device.

16. The mobile device of claim 15 further comprising a location sensor, and wherein the changes in the camera view are detected via the location sensor.

17. The mobile device of claim 11, wherein the tangible object comprises a surface covering, and wherein the instructions further cause the processor to overlay the three-dimensional representation of the tangible object on a surface detected in the scene.

18. The mobile device of claim 11, wherein the instructions further cause the processor to,
send the graphical representation of the scene to a service element via the network; and
receive geometry data of the scene from the service element via the network in response to sending the graphical representation of the scene, wherein the geometry data assists the mobile device in accurately displaying the three-dimensional representation of the tangible object within the graphical representation of the scene.

19. The mobile device of claim 18, wherein the instructions further cause the processor to facilitate a voice call between the mobile device and an operator via the service element, wherein the operator facilitates determining the geometry data.

20. A computer-readable medium having instructions stored thereon which are executable by a mobile device capable of being coupled to a network for performing steps comprising:
facilitating shopping for a tangible object via the network using the mobile device;
obtaining a graphical representation of a scene of a local environment using a sensor of the mobile device;
obtaining, via the network, graphical object data that enables a three-dimensional representation of the tangible object to be rendered on the mobile device, wherein the graphical object data is obtained in response to a shopping selection; and
displaying the graphic representation of the object with the graphical representation of the scene so that the appearance of the tangible object in the scene is simulated.

21. A server, comprising:
a network interface capable of communicating via a network;
a processor coupled to the network interface; and
a memory coupled to the processor, the memory including instructions that cause the processor to,
receive a request for e-commerce data related to a tangible object from a mobile device that is shopping for the tangible object via the network;
determine, based on the request, graphical object data that enables a three-dimensional representation of the tangible object to be rendered on the mobile device; and
send the e-commerce data and graphical object data to the mobile device so that the three-dimensional representation of the tangible object can be overlaid with a scene taken from a camera of the mobile device.

22. The server of claim 21, wherein the instructions further cause the processor to:
receive a graphical representation of the scene from the mobile device;
determine geometry data of the scene that assists the mobile device in overlaying the three-dimensional representation of the tangible object with the scene; and
send the geometry data to the mobile device via the network.

23. The server of claim 22, wherein the instructions further cause the processor to facilitate a voice call between the mobile device and an operator, wherein the operator facilitates determining the geometry data of the scene that assists the mobile device in overlaying the three-dimensional representation of the tangible object with the scene.
